(19) United States
(12) Patent Application Publication
(10) Pub. No.: US 2007/0245032 A1
(43) Pub. Date: Oct. 18, 2007

(54) System and method of a data blocker based on local monitoring of a soliciting website

(75) Inventors: Kaushal KishorVarshney, Santa Clara, CA (US); Shipra Varshney, Santa Clara, CA (US)

Correspondence Address: Raj Abhyanker, LLP;c/o Intellevate, P.O. Box 52050, Minneapolis, MN, 55402, US

(73) Assignee: Parent Approval LLC

(21) Appl. No.: 11/710,052

(22) Filed: Feb. 23, 2007

Related U.S. Application Data
(60) Provisional application No. 60/766,997, filed on Feb. 24, 2006.

(51) Int. Cl. G06F 15/16

(52) U.S. Cl. 709/229

(57) ABSTRACT

A system and method of an outbound data blocker based on local monitoring of a soliciting website is disclosed. In one embodiment, a method of a data blocker module associated with a personal computer includes generating a list of protected metadata based on at least one field data registered by a user having an access privilege to the data blocker module, detecting a website requesting a response data corresponding to one of the list of protected metadata when the website is accessed by a browser of a personal computer and determining a communication of the response data to the website through authenticating a provided password data processed by the data blocker module. In addition, the method may include installing the data blocker module to the personal computer such that the data blocker module is coupled to the browser of the personal computer.

### CLAIM OF PRIORITY

This application claims priority form provisional application Ser. No. 60/766,997 titled “computer program for detection of web-form presented by an internet website; and local authentication of the submission of this web-form” filed on Feb. 24^{th}, 2006.

### FIELD OF TECHNOLOGY

This disclosure relates generally to the technical fields of software and/or hardware technology and, in one example embodiment, to system and method of a data blocker based on local monitoring of a soliciting website.

### BACKGROUND

Data privacy may refer to an evolving relationship between technology and legal right to (e.g., public expectation of privacy) collects and/or share data. A privacy problem may exist when uniquely identifiable data relating to a person (e.g., which may be health information, a legal information, a financial information, a genetic information, a location information, an identity information, etc.) are collected and/or stored in a digital and/or another form and not being protected against an unauthorized usage. Improper and/or non-existent disclosure control may become a root cause for privacy issues. The most common sources of the data that may be subject to the data privacy may be to share the data while protecting the uniquely identifiable data.

An internal leak may occur when the person's confidential information is released to a third party (e.g., with an intent to defraud the person) through the Internet. Various types of data may be leaked through the Internet. In order to prevent the confidential information from the Internet leak, a data blocking device may be used (e.g., especially by a business entity) to monitor and/or restrict an access to the data. Although the necessity of the data blocking device may exist for a data processing device (e.g., a desktop computer, a laptop computer, a PDA, etc.), the data blocking device may not be affordable for an individual due to its high cost and/or complexity.

### SUMMARY OF THE DISCLOSURE

A system and method of a data blocker based on local monitoring of a soliciting website is disclosed. In one aspect a method of a data blocker module associated with a personal computer includes generating a list of protected metadata based on at least one field data registered by a user having an access privilege (e.g., access privilege to the data blocker module may be obtained when provided password data matches with a saved password data generated during an installation of the data blocker module to the personal computer), to the data blocker module detecting a website requesting a response data corresponding to one of the list of protected metadata when the website is accessed by a browser of the personal computer (e.g., the personal computer may be a desktop computer, a notebook computer, a personal digital assistant, a portable computer, a tablet computer, and/or a wearable computer) and determining a communication of the response data (e.g., the data blocker module may perform the communication of the response data when the website is a member of the list of trusted websites) to the website through authenticating (e.g., the data blocker module may block the communication of the response data by another user (e.g., the another user may be a youngster who needs a parental approval to perform the communication of the response data) who does not have the access privilege to the data blocker module) the provided password data processed by the data blocker module.

The method may further include installing the data blocker module to the personal computer such that the data blocker module is coupled to the browser (e.g., the browser may be Internet Explorer, a Mozilla, a Firefox, a Safari, a Netscape, an Opera, and/or other browsers) of the personal computer. In addition, the method may include embedding a logo of the data blocker module to a menu bar of a graphic user interface view of the website. Furthermore, the method may include generating a list of trusted websites based on any one web address registered by the user with the access privilege to the data blocker module. Moreover, the method may include rendering another list of protected metadata recommended by the data blocker module during the generating the list of protected metadata.

In another aspect a method of a data blocker module associated with a personal computer includes generating a list of protected metadata (e.g., the list of protected metadata may describe a financial information, a security information, a health information, a genetic information, an identity information, a legal information, and/or a location information) and/or any number of trusted websites through processing input data of a user having an access privilege to the data blocker module, rendering a pop up window requesting a provided password data when a website accessed by a browser associated with the data blocker module requests a response data described by any one of the list of protected metadata, and blocking a communication of the response data when the provided password data is not authenticated by the data blocker module. The website may not be a member of the trusted websites.

In addition, the method may include associating the data blocker module to the browser such that the data blocker module is triggered when the browser is accessed by the user of the personal computer. Moreover, the method may include performing the communication of the response data when the provided password data is authenticated by the data blocker module.

In yet another aspect, a system includes a data blocker module embedded in a data processing device to monitor a communication of each outbound data solicited by a website (e.g., a trusted website and/or a non-trusted website) through comparing a metadata of the outbound data to each of protected metadata registered with the data blocker module, the trusted website of a first server accessed by the data processing device to process the each outbound data through bypassing the data blocker module that may be performed when the website is a member of the first database of the trusted website, and/or the non-trusted website of a second server accessed by the data processing device to process the each outbound data when the communication of the each outbound data is authenticated by the data blocker module.

In addition, the system may include a configuration module of the data blocker module to create a first database of the trusted website and/or a second database of the protected metadata when the trusted website and/or the protected metadata are processed by the data blocker module. Moreover, the system may include a detector module of the data blocker module to determine the website accessed by a browser of the data processing device. Furthermore, the system may include a match module of the data blocker module to perform the comparing the metadata of the outbound data with each of the protected metadata of the second database.

Also, the system may include a password creation module to generate a saved password that may be used to authenticate a user accessing the data blocker module during an installation of the data blocker module. In addition, the system may include a password matching module to authenticate the user through comparing a provided password data of the user with the saved password.

The methods, systems, and apparatuses disclosed herein may be implemented in any means for achieving various aspects, and may be executed in a form of a machine-readable medium embodying a set of instruction that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a data blocker module of a data processing device communicating with sever(s) through a network, according to one embodiment.

FIG. 2 is an exploded view of the data blocker module, according to one embodiment.

FIG. 3 is a flow chart of installing the data blocker module to the personal computer, registering a list of protected metadata and list of trusted websites, according to one embodiment.

FIG. 4 is a graphical user interface view of the data blocker module of FIG. 1, according to one embodiment.

FIG. 5 is a flow chart of local monitoring of a soliciting website using the data blocker module, according to one embodiment.

FIG. 6 is a graphical user interface view of populating information associated with a user, according to one embodiment.

FIG. 7 is an exemplary view of user interaction with database and personal information, according to one embodiment.

FIG. 8 is a diagrammatic system view of a data processing system in which any of the embodiments disclosed herein may be performed, according to one embodiment.

FIG. 9 is a process flow of data blocker module, according to one embodiment.

FIG. 10 is a process flow of communicating a response data on authenticating the provided password data, according to one embodiment.

Other features of the present embodiments will be apparent from the accompanying drawings and from the detailed description that follows.

### DETAILED DESCRIPTION

A system and method of a data blocker based on local monitoring of a soliciting website is disclosed. In the following description, for the purposes of explanation, numerous specific details are set forth in order to provide a thorough understanding of the various embodiments. It will be evident, however to one skilled in the art that the various embodiments may be practiced without these specific details.

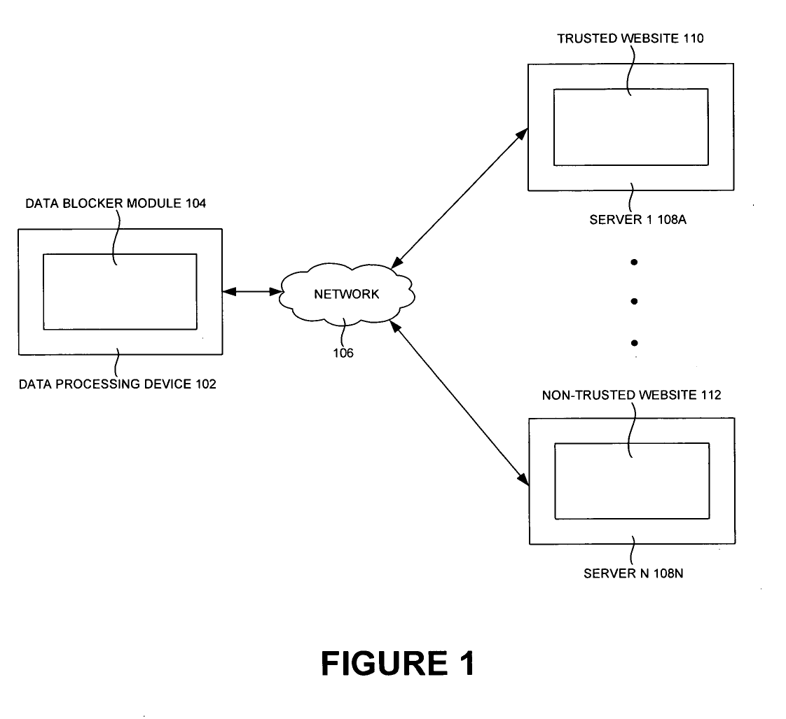

In one embodiment, a method of a data blocker module associated with a personal computer includes generating a list of protected metadata based on at least one field data registered by a user having an access privilege to the data blocker module (e.g., a data blocker module 104 of FIG. 1), detecting a website requesting a response data corresponding to one of the list of protected metadata when the website is accessed by a browser of the personal computer (e.g., a desktop computer, a notebook computer, a personal digital assistant, a portable computer, a tablet computer, and/or a wearable computer) and determining a communication of the response data to the website through authenticating a provided password data processed by the data blocker module.

In another embodiment, a method of a data blocker module associated with a personal computer includes generating a list of protected metadata (e.g., the list of protected metadata may describe a financial information, a security information, a health information, a genetic information, an identity information, a legal information, and/or a location information) and a number of trusted websites through processing input data of a user having an access privilege to the data blocker module (e.g., the data blocker module 104 of FIG. 1), rendering a pop up window requesting a provided password data when a website that may or may not be a member of the trusted websites) accessed by a browser associated with the data blocker module requests a response data described by any one of the list of protected metadata, and blocking a communication of the response data when the provided password data is not authenticated by the data blocker module.

In yet another embodiment, a system includes a data blocker module (e.g., the data blocker module 104 of FIG. 1) embedded in a data processing device (e.g., a data processing device 102 of FIG. 1) to monitor a communication of each outbound data solicited by a website (e.g., the website may include a trusted website and/or a non-trusted website) through comparing a metadata of the outbound data to each of protected metadata registered with the data blocker module, the trusted website (e.g., a trusted website 110 of FIG. 1) of a first server (e.g., a server 108A, server N 108N of FIG. 1) accessed by the data processing device to process the each outbound data through bypassing the data blocker module and the non-trusted website (e.g., a non-trusted website 112 of FIG. 1) of a second server (e.g., the sever 1 108A, the sever N 108N of FIG. 1) accessed by the data processing device to process the each outbound data when the communication of the each outbound data is authenticated by the data blocker module.

FIG. 1 is a system view of a data blocker module 104 of a data processing device 102 communicating with severs 1-N 108A-N through a network 106, according to one embodiment. Particularly, FIG. 1 illustrates the data processing device 102, the data blocker module 104, the network 106, the server(s) 1 108A (e.g., 2 108B, N 108N), a trusted website 110 and a non-trusted website 112, according to one embodiment. The data processing device 102 may be a device (e.g., a desktop computer, a notebook computer, a personal digital assistant) that may access a website (e.g., a trusted website or non-trusted website) to process each outbound data.

The data blocker module 104 may be embedded in the data processing device 102 to monitor communication of each outbound data solicited by a website (e.g., the trusted website 110 and the non-trusted website 112 of FIG. 1) that may block the communication of response data by another user (e.g., a youngster who needs a parental approval to perform the communication of the response data) who may not have the access privilege and/or may perform the communication of the response data when the website is a member of the list of trusted websites.

The network 106 may facilitate server(s) 1 108A (e.g., 2 108B, N 108N) to interact with the data processing device. The server(s) 1108A (e.g., 2 108B, N 108N) may be a computer that may contain the trusted website 110 and/or the non-trusted website 112 which may handle requests of data, emails, file transfers and/or other network services to provide the related information to the user on demand.

The trusted website 110 may be the website which is the member of the first database of the trusted websites registered by the users having the access privileges and may be bypassed by the data blocker module on accessing by the data processing device 102. The non-trusted website 112 may be the website which is not registered in the first database by the user and/or may be accessed by the data processing device when the communication of the each outbound data is authenticated by the data blocker module 104. In an example embodiment of FIG. 1, the data processing device 102, containing the data blocker module 104 may communicate with the server(s) 1 108A (e.g., 2 108B, N 108N).

For example, the list of protected metadata (e.g., the list of protected metadata may describe a financial information, a security information, a health information, a genetic information, an identity information, a legal information, and/or a location information) may be generated based on at least one field data registered by the user having the access privilege (e.g., the access privilege to the data blocker module 104 may be obtained when a provided password data matches with a saved password data generated during an installation of the data blocker module 104) to the data blocker module 104

Also, the website (e.g., the non-trusted website 112) requesting the response data corresponding to one of the list of protected metadata may be detected when the website is accessed by the browser of a personal computer (e.g., a desktop computer, a notebook computer, a personal digital assistant, a portable computer, a tablet computer, and a wearable computer). Another list of protected metadata recommended by the data blocker module 104 (e.g., the data blocker module 104 may perform the communication of the response data when the website is a member of the list of trusted websites 110) may be rendered during the generating the list of protected metadata.

Furthermore, the data blocker module 104 may block the communication of the response data by another user (e.g., the another user may be a youngster who may need a parental approval to perform the communication of the response data) who does not have the access privilege to the data blocker module 104. In addition, a list of protected metadata and/or any number of trusted websites may be generated through processing input data of the user having the access privilege to the data blocker module 104.

The system includes the data blocker module 104, embedded in the data processing device 102 to monitor the communication of each outbound data solicited by the website (e.g., website may include any one of the trusted website 110 and the non-trusted website 112) through comparing the metadata of the outbound data to each of protected metadata registered with the data blocker module 104.

Furthermore, the system includes the trusted website 110 of the first server (e.g., the server 1 108A, the server N 108N of FIG. 1) accessed by the data processing device 102 to process the each outbound data through bypassing the data blocker module 104 (e.g., bypassing the data blocker module 104 may be performed when the website is a member of the first database of the trusted website 110). Also, the system includes the non-trusted website 112 of the second server accessed by the data processing device 102 to process the each outbound data when the communication of the each outbound data is authenticated by the data blocker module 104.

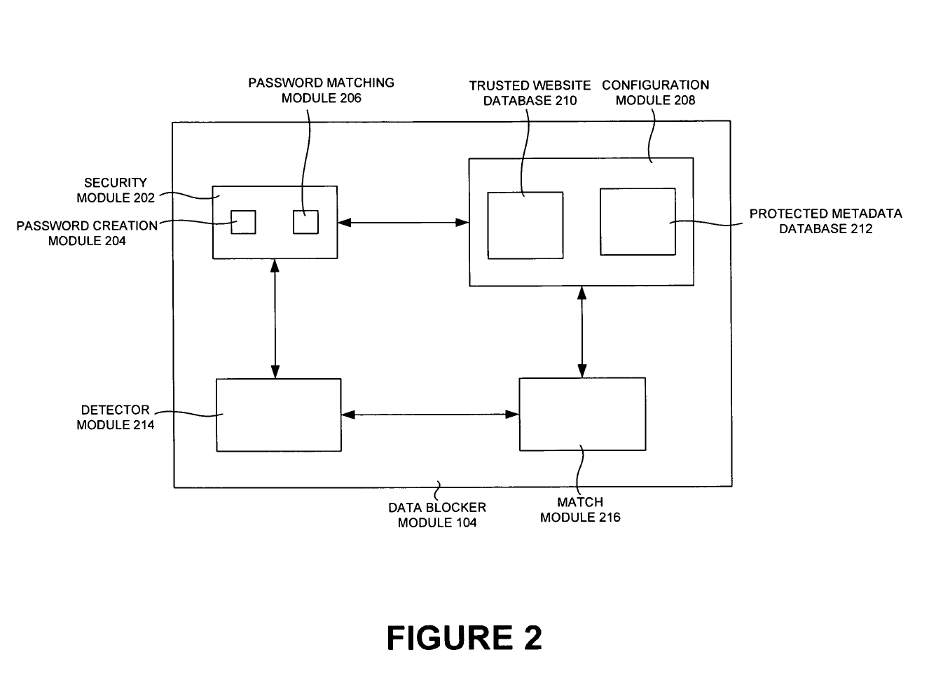

FIG. 2 is an exploded view of a data blocker module 104 of FIG. 1, according to one embodiment. Particularly, FIG. 2 illustrates a security module 202, a password creation module 204, a password matching module 206, a configuration module 208, a trusted website database 210, a protected metadata database 212, a detector module 214 and a match module 216, according to one embodiment.

The security module 202 may allow the user having the access privilege to the data blocker module 104 to create and/or save the password during installation of the data blocker module (e.g., the data blocker module 104 of FIG. 1). The password creation module 204 may generate the saved password during an installation of the data blocker module 104. The password matching module 206 may authenticate the user through comparing the provided password data of the user with the saved password generated by the password creation module 204 during installation of the data blocker module 104. The configuration module 208 may create the first database of the trusted website (e.g., the trusted website 110 of FIG. 1) and/or a second database of the protected metadata when the trusted website and/or the protected metadata are processed by the data blocker module.

The trusted website database 210 may be a database of the websites, and may contain the list the trusted websites registered by the users having access privileges to the data blocker module. The protected metadata database 212 may be the database embedded in the configuration module 208 that may contain the protected metadata registered by the users having access privilege to the data blocker module. The detector module 214 may detect the website accessed by a browser (e.g., an Internet Explorer, a Mozilla, a Firefox, a Safari, a Netscape, an Opera, etc.) of the data processing device. The match module 216 may compare the metadata of the outbound data with each of the protected metadata of the second database.

In example embodiment illustrated in FIG. 2, the security module 202 may contain the password creation module 204 and the password matching module 206 and may communicate with the configuration module 208 and the detector module 214. The match module 216 may communicate with the configuration module 208 and the detector module 214 as illustrated in example embodiment of FIG. 2.

For example, the communication of the response data to the website may be determined through authenticating the provided password data processed by the data blocker module 104. Also, the list of trusted websites may be generated based on any one web address, registered by the user with the access privilege to the data blocker module 104. In addition, another list of protected metadata recommended by the data blocker module 104 may be created during the generating the list of protected metadata. Furthermore, the system may include the configuration module 208 of the data blocker module 104 to create the first database (e.g., the trusted website database 210 of FIG. 2) of the trusted website and/or the second database (e.g., the protected metadata database 212 of FIG. 2) of the protected metadata when the trusted website and/or the protected metadata are processed by the data blocker module 104.

Also, the system may include the detector module 214 of the data blocker module 104 to determine the website accessed by a browser of the data processing device (e.g., the data processing device 102 of FIG. 1). In addition, the system may include the match module 216 of the data blocker module 104 to perform the comparing the metadata of the outbound data with each of the protected metadata of the second database.

Furthermore, the system may include the password creation module 204 to generate a saved password that may used to authenticate the user accessing the data blocker module 104 during the installation of the data blocker module 104. Moreover, the system may include the password matching module 206 to authenticate the user through comparing a provided password data of the user with the saved password.

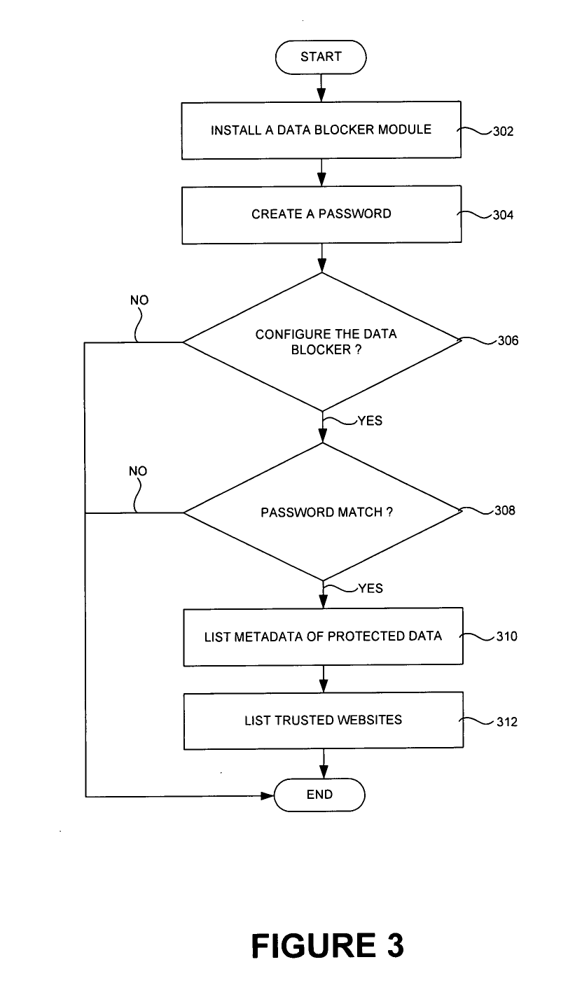

FIG. 3 is a flow chart of installing a data blocker module 104 to the personal computer, registering a list of protected metadata and list of trusted websites, according to one embodiment. In operation 302, the data blocker module (e.g., the data blocker module 104 of FIG. 1) may be installed to the personal computer (e.g., the laptop, PDA device, desktop, etc.) such that the data blocker module is coupled to the browser (e.g., an Internet Explorer, a Mozilla, a Firefox, a Safari, a Netscape, an Opera, and/or other browsers) of the personal computer. In operation 304, the password may be created by the user having the administrative privilege to the personal computer (e.g., through a password creation module 204 of FIG. 2).

In operation 306, it is determined whether the data blocker is configured or not. If it is determined that the data blocker module is not configured, then the process will be terminated. In operation 308, it is determined whether the provided password data matches with the saved password data generated during installation of the data blocker module to the personal computer. If it is determined that the provided password data does not match with the saved password data, then the process will be terminated.

In operation 310, the list of protected metadata is generated based on field data (e.g., account information, credit card info, billing info, etc.) registered by the user having the access privilege to the data blocker module if the provided password data matches with the saved password data. In operation 312, the list of trusted website is generated based on the web address registered by the user having the access privilege to the data blocker module.

For example, the data blocker module (e.g., the data blocker module 104 of FIG. 1-2) may be installed to the personal computer (e.g., a desktop computer, a notebook computer, a personal digital assistant, a portable computer, a tablet computer, and a wearable computer) such that the data blocker module is coupled to the browser (e.g., an Internet Explorer, a Mozilla, a Firefox, a Safari, a Netscape, an Opera, and/or other browsers) of the personal computer. Also, the list of trusted websites may be generated based on any of the web address registered by the user having the access privilege to the data blocker module.

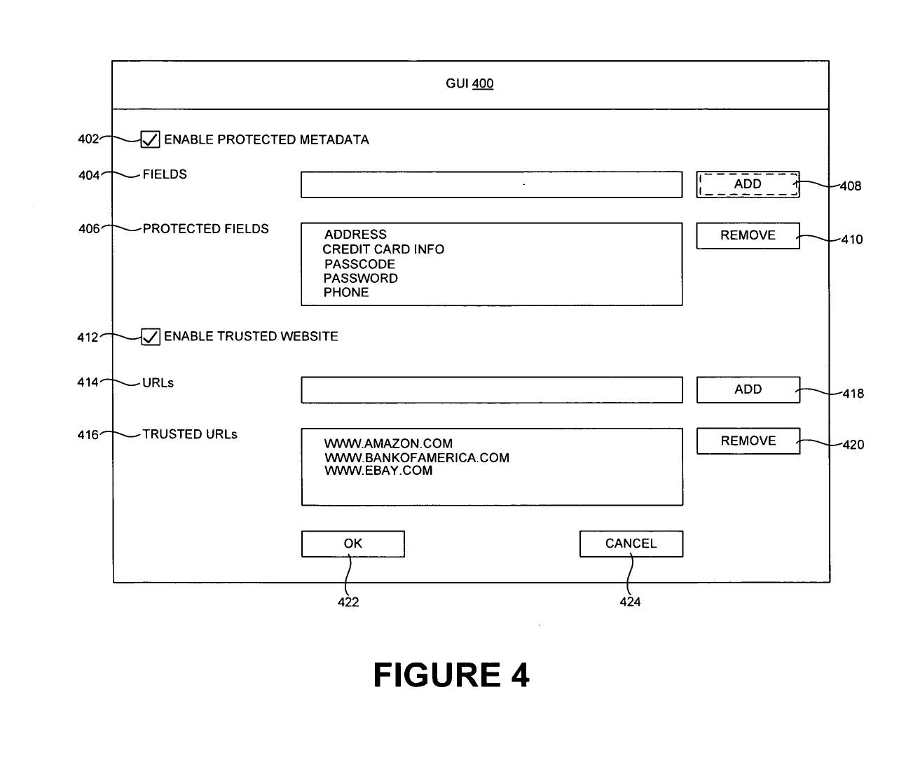

FIG. 4 is a graphical user interface view of the data blocker module 104 of FIG. 1, according to one embodiment. Particularly, FIG. 4 illustrates an enable protected metadata field 402, fields field 404, a protected fields 406, an add option 408, a remove option 410, an enable trusted website field 412, URLs field 414, a trusted URLs field 416, an add option 418, a remove option 420, OK option 422, and cancel option 424, according to one embodiment.

The enable protected metadata field 402 may be a check box that may enable the user to list the metadata to be protected from being displayed on the website. The fields field 404 may enable the user, having the access privileges to add the metadata, to be protected through add option 408.

The protected fields 406 may contain the list of the protected metadata registered by the user having access privileges to the data blocker module. The remove option 410 may facilitate the user having the access privileges to the data blocker module to remove the metadata from the protected fields 406 registered by the user. Similarly, the enable trusted website field 412 may be a check box, when checked may enable bypassing of the trusted website through the data blocker module.

The URLs field 414 may be the web addresses which the user may consider a trusted website. The trusted URLs field 416 may contain the list of the trusted websites added through the add option 418. The remove option 420 may enable the user having the access privileges to delete the web addresses from the trusted URLs list. The OK option may allow the user to save the changes made in the list of metadata and/or the list of trusted website.

In example embodiment illustrated in FIG. 4, the GUI 400 may enable the user having the access privileges to the data blocker module, to register a list of metadata to be protected from revealing on the website. The GUI 400 may also facilitate the user having access to the data blocker module to register the list of trusted website to be bypassed through the data blocker module. In example embodiment illustrated in FIG. 4, the GUI 400 of the data blocker module may facilitate the user having the access privileges to activate the protected metadata and/or trusted websites.

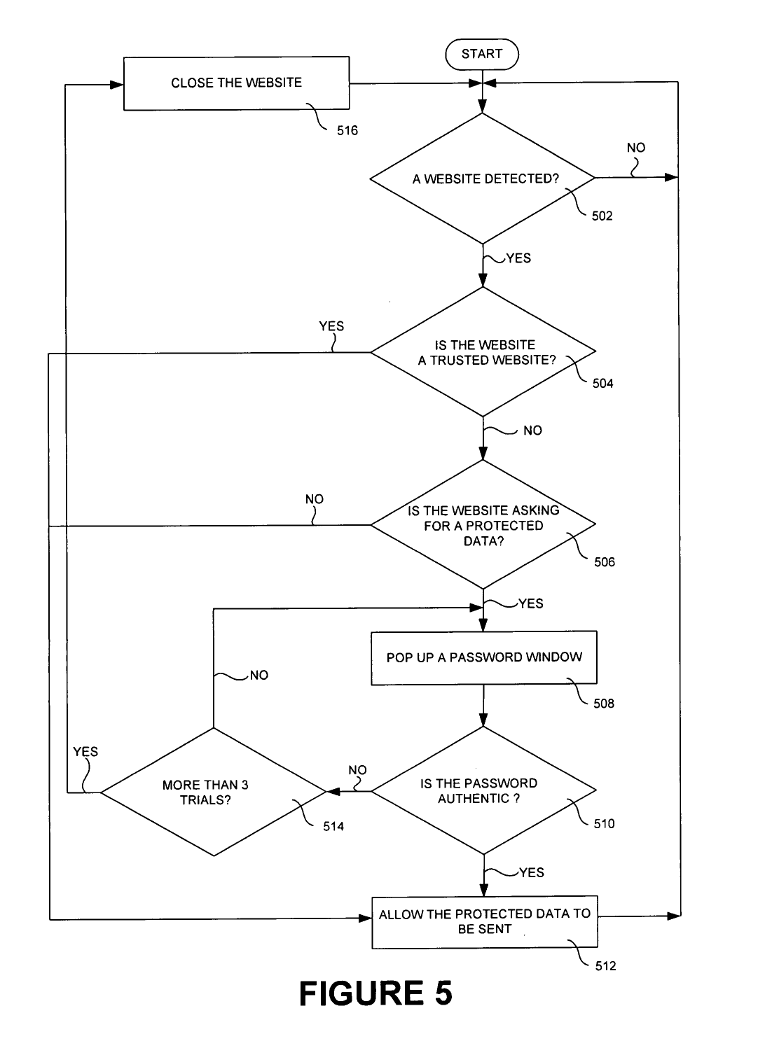

FIG. 5 is a flow chart of local monitoring of a soliciting website using the data blocker module 104 of FIG. 1, according to one embodiment. In operation 502, it is determined whether the website (e.g., the trusted website 110 and the non-trusted website 112 of FIG. 1) is detected or not when the user accesses the browser, associated with the data blocker module. If the website is not detected, then data blocker module continues accessing the browser. In operation 504, it is determined whether the website accessed by the browser of the data processing device (e.g., the data processing device 102 of FIG. 1) is the member of the first database (e.g., the trusted website database 210 of FIG. 2) of the trusted website (e.g., the trusted website 110 of FIG. 1) or not. If the website accessed by the browser of the data processing device is the member of the first database of the trusted website, then the trusted website is bypassed through the data blocker module thereby allowing the user send the protected data requested by the website.

In operation 506, it is determined whether the website accessed by the browser requests the response data, described by any one of the list of protected metadata, if website is not the member of the first databases of the trusted website. In operation 508, the password window may pop-up when the non-trusted website (e.g., the non-trusted website 112 of FIG. 1) requests the response data described in any one of the list of protected metadata.

In operation 510, it is determined whether the provided password data is authenticated by the data blocker module or not. In operation 512, the user may be allowed to send the response data described in any one of the list of protected metadata requested by the non-trusted website (e.g., the non-trusted website 112 of FIG. 1), when the provided password data is authenticated by the data blocker module.

In operation 514, it is determined whether data blocker module prompts the password data for more than three times or not. The password window may pop-up for a maximum number of three times when the provided password data does not match with the saved password data. In case the above condition is not satisfied, in operation 516, the website may be closed

For example, the pop up window may be rendered requesting the provided password data when the website, accessed by the browser associated with the data blocker module requests the response data described by any one of the list of protected metadata. Also, the communication of the response data may be blocked when the provided password data is not authenticated by the data blocker module (e.g., the data blocker module 104 of FIG. 1-2).

Furthermore, the data blocker module may be associated to the browser such that the data blocker module is triggered when the browser is accessed by a user of the personal computer (e.g., the desktop computer, the notebook computer, the personal digital assistant, the portable computer, the tablet computer, and/or the wearable computer). Additionally, the communication of the response data may be performed when the provided password data is authenticated by the data blocker module.

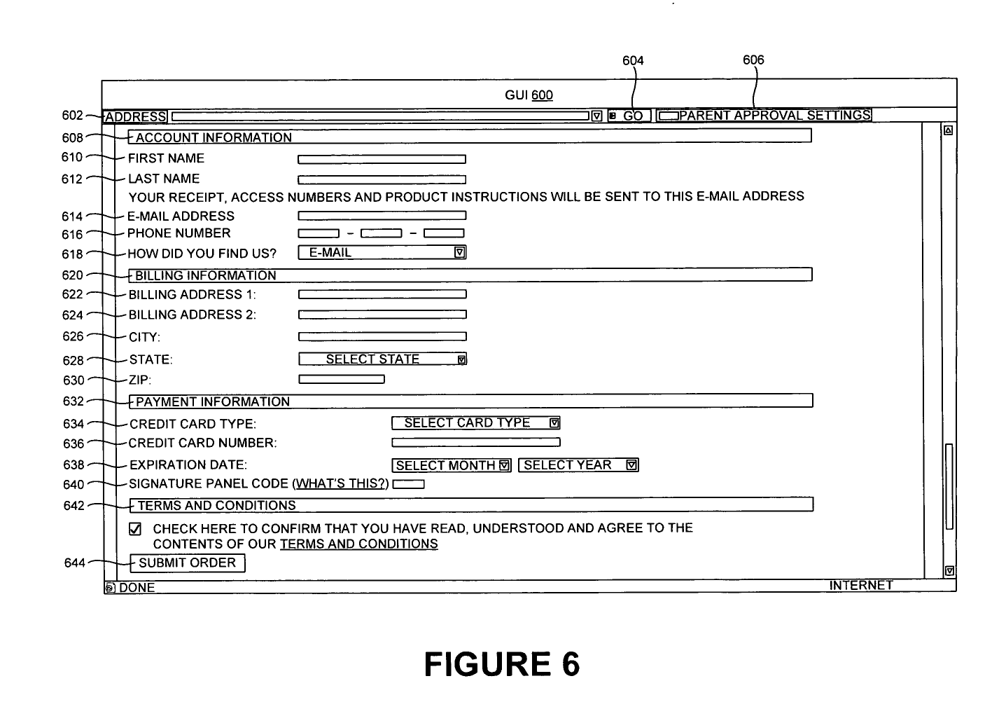

FIG. 6 is a graphical user interface view of populating information associated with a user, according to one embodiment. Particularly FIG. 6 illustrates exemplary screen displaying an address field 602, a go link 604, a parent approval settings option 606, an account information field 608, a first name field 610, a last name field 612, an e-mail address field 614, a phone number field 616, a how did you find us? field 618, a billing information field 620, a billing address 1 field 622, a billing address 2 field 624, a city field 626, a state field 628, a zip field 630, a payment information field 632, a credit card type field 634, credit card number field 636, an expiration date field 638, a signature panel code field 640, a terms and conditions field 642, and a submit order field 644, according to one embodiment.

The address field 602 may enable the user enter URL of the website that the user wishes to browse through browser window. The go link 604 may be used to search the information entered in the address field 602. The parent approval settings option 606 may be a tool bar embedded into the browser on the installing the data blocker module to monitor the website. The account information field 608 may contain the first name field 610, the last name field 612, the e-mail address field 614, the phone number field 616, and how did you find us? field 618. The first name field 610 may be the first name of the user of the personal computer and the last name field 612 may be the last name of the user. The e-mail address field 614 may request the user to enter the email address associated with the user. The phone number field 616 may be the user's phone number on which the user may be contacted. How did you find us? field 618 may be the website asking information of how the user knows about the website. The billing information field 620 may be the user's address for communication and/or interaction. The billing information field 620 may include billing address 1 field 622 that may be plot number and/or street, the billing address 2 field 624 may be the other plot number and/or street associated with the user, city field 626, state field 628, and the zip field 630 may be the other information associated with the user.

The payment information field 632 may be the procedure and/or associated computer networks used to settle financial transactions in bond markets, currency markets, and/or derivatives and options markets. The payment information field 632 may include the credit card type field 634, the credit card number field 636, the expiration date field 638, and the signature panel code field 640. The credit card type field 634 may specify the type of credit card used by the user and it will provide an option to select the card type through drop down box.

The credit card number field 636 may be the personal identification number provided to the user (e.g., owner of the credit card). The expiration date field 638 may indicate the expiry date of the credit card. The signature panel code field 640 may be specially formulated with built in security and tamper evident features that may discolor if attempts are made to remove and/or alter the cardholder's signature. The signature panel code field 640 may be available in solid white, matte clear, and/or imprinted in one or more colors over a white background. The terms and conditions field 642 may provide a check box to confirm that the user may have read, understood, and agreed to the contents of their terms and conditions. The submit order field 644 may be used to submit the above mentioned details to the website.

In example embodiment illustrated in FIG. 6, the GUI 600 may facilitate the user to enable or disable the data blocker module embedded in the toolbar of the browser. The GUI may also enable be the user having the access privileges to present the response data requested by the website on authentication by the data blocker module (e.g., the data blocker module authenticates when the provided password data matches with the saved password data. For example, a logo of the data blocker module (e.g., the data blocker module 104 of FIG. 1) may be embedded to a menu bar of a graphic user interface view of the website.

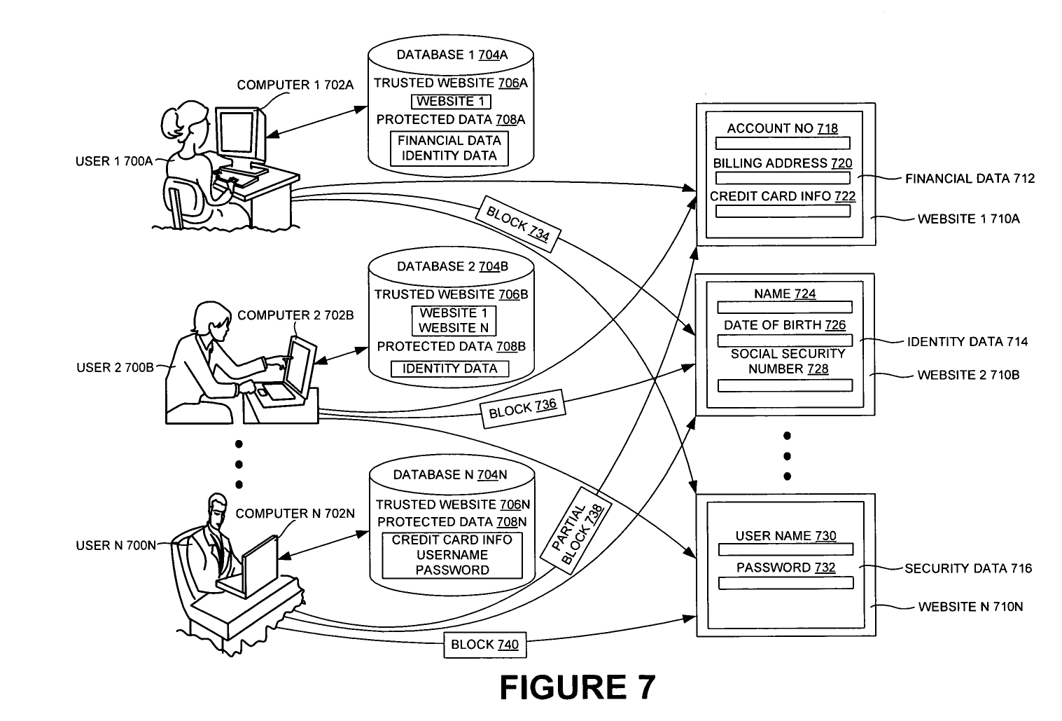

FIG. 7 is an exemplary view of locally monitoring a soliciting website, according to one embodiment. Particularly, FIG. 7 illustrates a user 1 700A, a user 2 700B, a user N 700N, a computer 1 702A, a computer 2 702B, a computer N 702N, a database 1 704A, a database 2 704B, a database N 704N, a trusted website 706A, a trusted website 706B, a trusted website 706N, a protected data 708A, a protected data 708B, a protected data 708N, a website 1 710A, a website 2 710B, a website N 710N, a financial data 712, an identity data 714, a security data 716, an account no 718, a billing address 720, a credit card info 722, a name 724, a date of birth 726, a social security number 728, a user name 730, a password 732, a block 734, a block 736, a partial block 738, a block 740, according to one embodiment.

The user 1700A is a person using the computer 1 702A. The user 2 700B is a person using the computer 2 702B. The user N 700N is a person using the computer N 702N. A first data blocker of the computer 1 702A is associated with the database 1 704A which has “website 1” as the trusted website 706A and “financial data” and “identity data” as the protected data 708A. A second data blocker of the computer 2 702B is associated with the database 2 704B which has “website 1” and “website N” as the trusted website 706B and “identity data” as the protected data 708B. A Nth data blocker of the computer N 702N is associated with the database N 704N which has “credit card info,” “user name,” and “password” as the protected data 708N.

The financial data 712 sought by the website 1 710A includes the account no 718, the billing address 720, and the credit card info 722. The identity data 714 sought by the website 2 710B includes the name 724, the date of birth 726, and the number 728. The security data 716 sought by the website N 710N includes the user name 730 and the password 732. In one example embodiment, the user 1 700A may be blocked (e.g., the block 734) from sending out the identity data 714 to the website 2 710B because the identity data 714 is a member of the protected data 708A and the website 2 710 is not a member of the trusted website 706A. However, the user 1 700A may override the block 734 by entering a password which authenticates the user 1700A.

The user 2 702B may be blocked (e.g., the block 736) from sending out the identity data 714 to the website 2 710B because the identity data 714 is a member of the protected data 708B and the website 2 710B is not a member of the trusted website 706B. However, the user 2 702B may override the block 736 by authenticating himself with the password. In another example embodiment, the user N 700N may be partially blocked (e.g., the partial block 738) from sending the credit card info 722 to the website 1 710A because the credit card info 722 is a member of the protected data 708N and the website 1 710A is not a member of the trusted website 706N. In addition, the user N 700N may be blocked (e.g., the block 740) from sending the security data 716 to the website N 710N because the security data 716 is not a member of the protected data 708N and the website N 710N is not a member of the trusted website 706N.

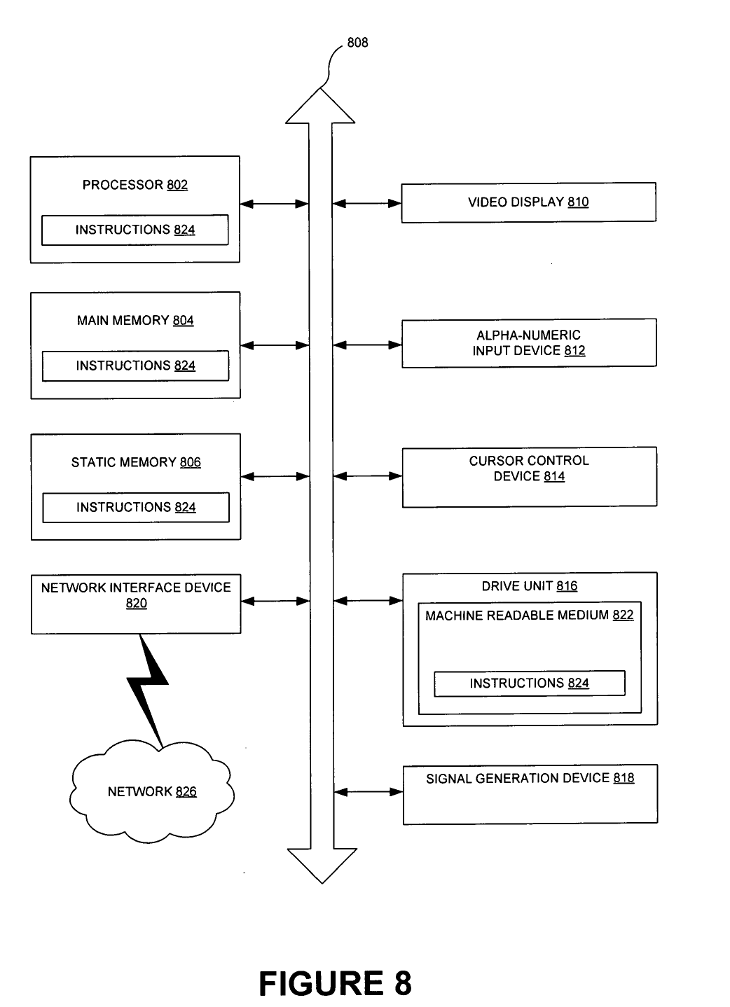

FIG. 8 is a diagrammatic system view 800 of a data processing system in which any of the embodiments disclosed herein may be performed, according to one embodiment. Particularly, the diagrammatic system view 800 of FIG. 8 illustrates a processor 802, a main memory 804, a static memory 806, a bus 808, a video display 810, an alpha-numeric input device 812, a cursor control device 814, a drive unit 816, a signal generation device 818, a network interface device 820, a machine readable medium 822, instructions 824, and a network 826, according to one embodiment.

The diagrammatic system view 800 may indicate a personal computer and/or a data processing system in which one or more operations disclosed herein are performed. The processor 802 may be microprocessor, a state machine, an application specific integrated circuit, a field programmable gate array, etc. (e.g., Intel® Pentium® processor). The main memory 804 may be a dynamic random access memory and/or a primary memory of a computer system.

The static memory 806 may be a hard drive, a flash drive, and/or other memory information associated with the data processing system. The bus 808 may be an interconnection between various circuits and/or structures of the data processing system. The video display 810 may provide graphical representation of information on the data processing system. The alpha-numeric input device 812 may be a keypad, keyboard and/or any other input device of text (e.g., a special device to aid the physically handicapped). The cursor control device 814 may be a pointing device such as a mouse.

The drive unit 816 may be a hard drive, a storage system, and/or other longer term storage subsystem. The signal generation device 818 may be a bios and/or a functional operating system of the data processing system. The network interface device 820 may be a device that may perform interface functions such as code conversion, protocol conversion and/or buffering required for communication to and from the network 826. The machine readable medium 822 may provide instructions on which any of the methods disclosed herein may be performed. The instructions 824 may provide source code and/or data code to the processor 802 to enable any one/or more operations disclosed herein.

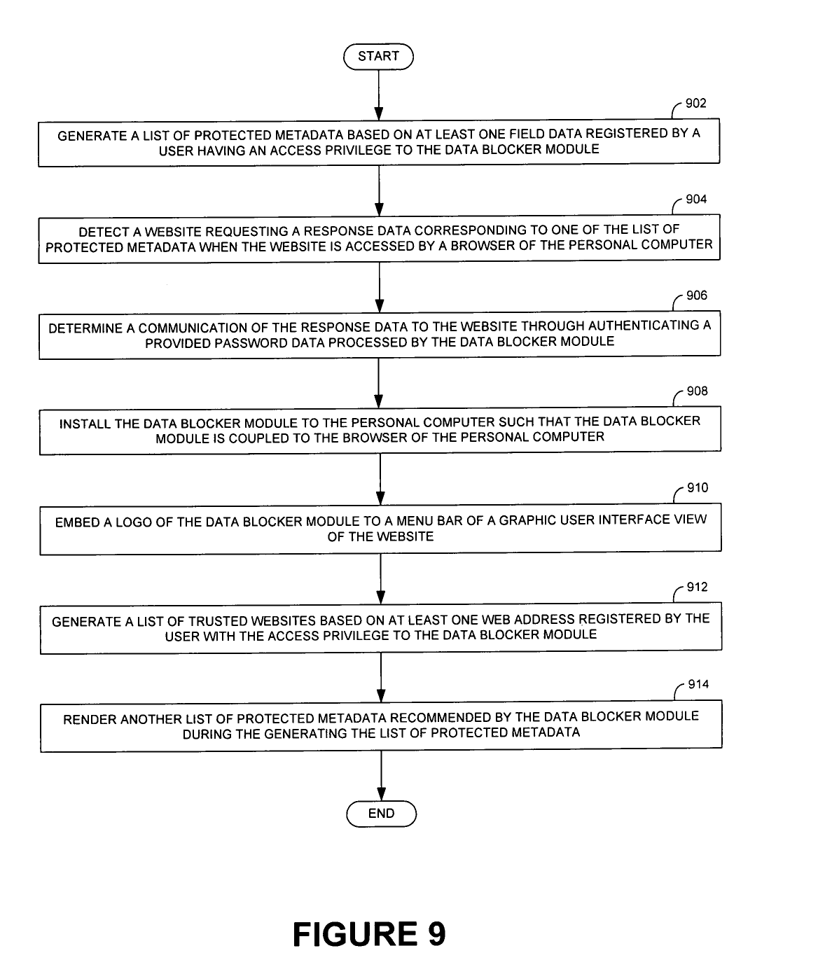

FIG. 9 is a process flow of data blocker module 104 of FIG. 1, according to one embodiment. In operation 902, a list of protected metadata may be generated based on at least one field data registered by a user having an access privilege to the data blocker module (e.g., the data blocker module 104 of FIG. 1). In operation 904, a website requesting a response data corresponding to one of the list of protected metadata may be detected when the website is accessed by a browser of the personal computer.

In operation 906, a communication of the response data to the website may be determined through authenticating a provided password data processed by the data blocker module. In operation 908, the data blocker module may be installed to the personal computer such that the data blocker module is coupled to the browser of the personal computer. In operation 910, a logo of the data blocker module may be embedded to a menu bar of a graphic user interface view of the website.

In operation 912, a list of trusted websites may be generated based on at least one web address registered by the user with the access privilege to the data blocker module. In operation 914, another list of protected metadata recommended by the data blocker module may be rendered during the generating the list of protected metadata.

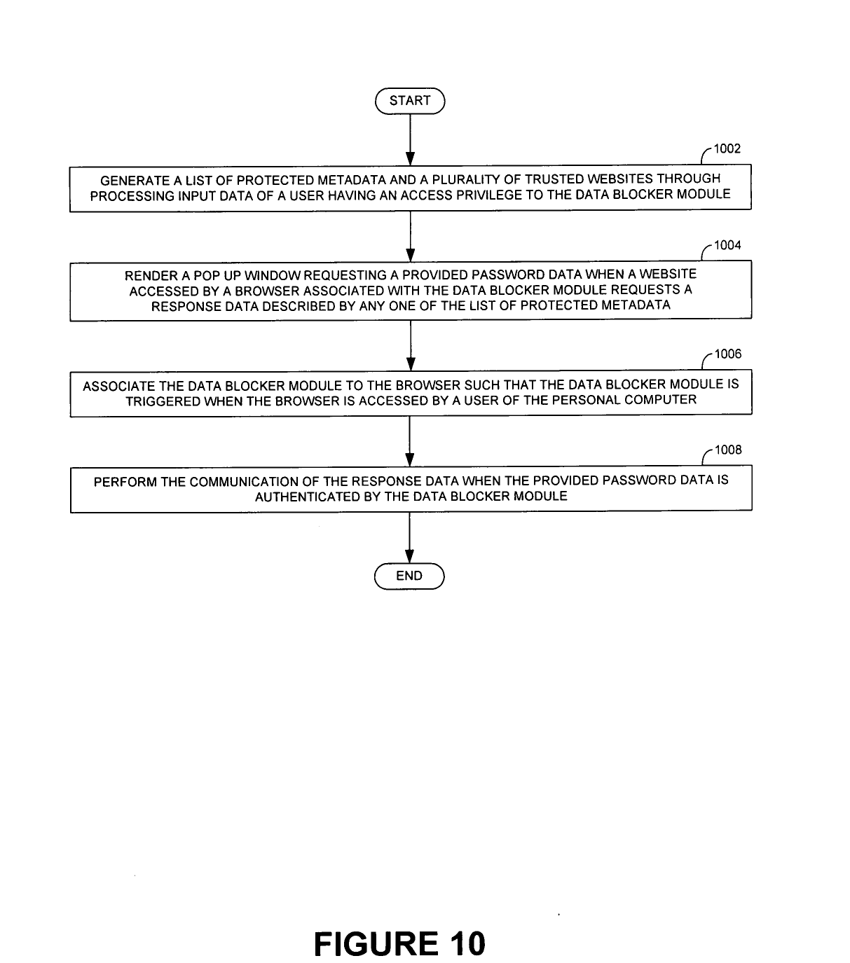

FIG. 10 is a process flow of communicating a response data on authenticating the provided password data, according to one embodiment. In operation 1002, a list of protected metadata and/or any number of trusted websites may be generated through processing input data of a user having an access privilege to the data blocker module (e.g., the data blocker module 104 of FIG. 1). In operation 1004, a pop up window requesting a provided password data may be rendered when a website accessed by a browser associated with the data blocker module requests a response data described by any one of the list of protected metadata.

In operation 1006, the data blocker module may be associated to the browser such that the data blocker module is triggered when the browser is accessed by a user of the personal computer. In operation 1008, the communication of the response data may be performed when the provided password data is authenticated by the data blocker module.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry and/or in Digital Signal; Processor DSP circuitry).

For example, the data blocker module 104, the security module 202, the password creation module 204, the password matching module 206, the configuration module 208, the detector module 214, the match module 216 of FIGS. 1-10 may be embodied through the data blocker circuit, the security circuit, the password creation circuit, the password matching circuit, the configuration circuit, and other circuits using one or more of the technologies described herein.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a data blocker module associated with a personal computer, comprising:
generating a list of protected metadata based on at least one field data registered by a user having an access privilege to the data blocker module;
detecting a website requesting a response data corresponding to one of the list of protected metadata when the website is accessed by a browser of the personal computer; and
determining a communication of the response data to the website through authenticating a provided password data processed by the data blocker module.

2. The method of claim 1, wherein the personal computer to include at least one of a desktop computer, a notebook computer, a personal digital assistant, a portable computer, a tablet computer, and a wearable computer.

3. The method of claim 2, wherein the access privilege to the data blocker module is obtained when the provided password data matches with a saved password data generated during an installation of the data blocker module to the personal computer.

4. The method of claim 3, further comprising installing the data blocker module to the personal computer such that the data blocker module is coupled to the browser of the personal computer, wherein the browser to include at least one of an Internet Explorer, a Mozilla, a Firefox, a Safari, a Netscape, an Opera, and other browsers.

5. The method of claim 4, further comprising embedding a logo of the data blocker module to a menu bar of a graphic user interface view of the website.

6. The method of claim 5, further comprising generating a list of trusted websites based on at least one web address registered by the user with the access privilege to the data blocker module.

7. The method of claim 6, wherein the data blocker module to perform the communication of the response data when the website is a member of the list of trusted websites.

8. The method of claim 7, further comprising rendering another list of protected metadata recommended by the data blocker module during the generating the list of protected metadata.

9. The method of claim 1, wherein the data blocker module to block the communication of the response data by another user who does not have the access privilege to the data blocker module, wherein the another user to include at least a youngster who needs a parental approval to perform the communication of the response data.

10. The method of claim 1 in a form of a machine-readable medium embodying a set of instructions that, when executed by a machine, causes the machine to perform the method of claim 1.

11. A method of a data blocker module associated with a personal computer, comprising:
generating a list of protected metadata and a plurality of trusted websites through processing input data of a user having an access privilege to the data blocker module;
rendering a pop up window requesting a provided password data when a website accessed by a browser associated with the data blocker module requests a response data described by any one of the list of protected metadata, wherein the website is not a member of the plurality of trusted websites; and
blocking a communication of the response data when the provided password data is not authenticated by the data blocker module.

12. The method of claim 11, wherein the list of protected metadata to describe at least one of a financial information, a security information, a health information, a genetic information, an identity information, a legal information, and a location information.

13. The method of claim 12 further comprising associating the data blocker module to the browser such that the data blocker module is triggered when the browser is accessed by a user of the personal computer.

14. The method of claim 13 further comprising performing the communication of the response data when the provided password data is authenticated by the data blocker module.

15. A system, comprising:
a data blocker module embedded in a data processing device to monitor a communication of each outbound data solicited by a website through comparing a metadata of the outbound data to each of protected metadata registered with the data blocker module;
a trusted website of a first server accessed by the data processing device to process the each outbound data through bypassing the data blocker module; and
a non-trusted website of a second server accessed by the data processing device to process the each outbound data when the communication of the each outbound data is authenticated by the data blocker module, wherein the website to include at least one of the trusted website and the non-trusted website.

16. The system of claim 15, further comprising a configuration module of the data blocker module to create a first database of the trusted website and a second database of the protected metadata when the trusted website and the protected metadata are processed by the data blocker module.

17. The system of claim 16, further comprising a detector module of the data blocker module to determine the website accessed by a browser of the data processing device, wherein the bypassing the data blocker module is performed when the website is a member of the first database of the trusted website.

18. The system of claim 17, further comprising a match module of the data blocker module to perform the comparing the metadata of the outbound data with each of the protected metadata of the second database.

19. The system of claim 18 further comprising a password creation module to generate a saved password during an installation of the data blocker module, wherein the saved password is used to authenticate a user accessing the data blocker module.

20. The system of claim 19 further comprising a password matching module to authenticate the user through comparing a provided password data of the user with the saved password.
